(19) United States
(12) Patent Application Publication
(10) Pub. No.: US 2013/0238375 A1
(43) Pub. Date: Sep. 12, 2013

(54) EVALUATING EMAIL INFORMATION AND AGGREGATING EVALUATION RESULTS

(71) Applicants: Sven Graupner, Mountain View, CA (US); Claudio Bartolini, Palo Alto, CA (US); Hamid Reza Motahari Nezhad, Los Altos, CA (US)

(72) Inventors: Sven Graupner, Mountain View, CA (US); Claudio Bartolini, Palo Alto, CA (US); Hamid Reza Motahari Nezhad, Los Altos, CA (US)

(21) Appl. No.: 13/415,814

(22) Filed: Mar. 8, 2012

(51) Int. Cl. G06Q 10/00

(52) U.S. Cl. 705/7.11

(57) ABSTRACT

A system including one or more processors and memory. The memory stores computer-executable instructions that control the one or more processors to receive a set of emails, process the set of emails to produce information related to the set of emails, evaluate the information related to the set of emails to answer one or more questions and produce evaluation results, and aggregate the evaluation results into a feedback report.

### BACKGROUND

Managing a business includes obtaining feedback from customers and markets. This feedback can be used to enhance sales opportunities and improve product and/or service offerings. Timely feedback increases the benefits that come from gathering the feedback.

Typically, sales personnel enter and update information in an enterprise information system or computer system that includes tools, such as a customer relationship management tool and/or a process tracking and reporting tool. The sales personnel manually enter the information and there is no guarantee of relevance, timeliness, completeness, or correctness of gathered information. Also, feedback usually isn't available until after a sale closes and little or no feedback is provided if a sale fails to close, resulting in the loss of information. Surveys and workshops with sales personnel provide some informal feedback, but often with long delays.

For these and other reasons, a need exists for the present invention.

### BRIEF DESCRIPTION OF THE DRAWINGS

FIG. 1 is a diagram illustrating one example of a computer system that includes a service sales feedback collection system.

FIG. 2 is a diagram illustrating one example of a service sales feedback collection system.

FIG. 3 is a diagram illustrating one example of a tag server.

FIG. 4 is a diagram illustrating one example of a case feedback extraction system.

FIG. 5 is a diagram illustrating one example of a feedback aggregator.

FIG. 6 is a flow chart diagram illustrating one example of a service sales feedback collection system.

FIG. 7 is a flow chart diagram illustrating one example of constructing an index via a tag server.

FIG. 8 is a flow chart diagram illustrating one example of a case feedback extraction system retrieving a set of emails from a tag server.

FIG. 9 is a flow chart diagram illustrating one example of a case feedback extraction system constructing a concept graph.

FIG. 10 is a flow chart diagram illustrating one example of constructing a concept dictionary.

FIG. 11 is a flow chart diagram illustrating one example of retrieving feedback from a service sales feedback collection system.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various embodiments described herein may be combined with each other, unless specifically noted otherwise.

In a service sales business, people, referred to herein as sales personnel, translate customer requirements into compositions of service packages. During this process, information is available about which service offerings are considered, how the service offerings are adjusted for a customer, how the service offerings can be sourced and priced in a region, and other items. However, after the sales effort closes, at least some of this information is not reported back to service line owners and lost.

Where sales personnel manually enter and update information into an information system, the complexity of the tools puts a burden on the sales personnel and the rigidity of the tools often does not allow for capturing relevant information. As a result, information gathered is often outdated and partial. Also, information gathering becomes more complicated as sales cases progress to other systems, leading to duplication of effort and increased manual effort. Problems encountered include: a significant amount of time and training imposed on the sales personnel for entering, maintaining, and searching for information; information becomes scattered and duplicated across systems as cases progress in lifecycle; the closed systems and scattered information makes analysis of data difficult; and time delays between the occurrence of an event and it being entered into the system can be significant.

A service sales feedback collection system, as described herein, eliminates or minimizes these and other problems. The service sales feedback collection system provides for the systematic collection of service sales and request for proposal/response information while the sales personnel work on cases with customers. To do this, the service sales feedback collection system captures email conversations (emails) and extracts information from the emails.

Email is widely used for communication between sales personnel and customers, including establishing contacts, scheduling appointments, and exchanging ideas and materials. Capturing emails around sales cases provides information, including fine-grain information, which can be extracted from the emails. Obstacles to using emails include: corporate email being considered legally personal in many countries, such that it can't be tapped into or processed for purposes of analysis; people need to be aware of and have explicit control over which emails are captured to avoid these legal issues; people also need incentive to contribute; and categorizing emails in relation to cases instead of people.

In the service sales feedback collection system, people have explicit control over sharing emails with the collection system by consciously deciding to copy email to the collection system. Also, an incentive for sharing comes from reduced reporting, automated feedback generation, and fine-grained information traceability. In addition, emails are automatically categorized via character strings or tags used in the emails.

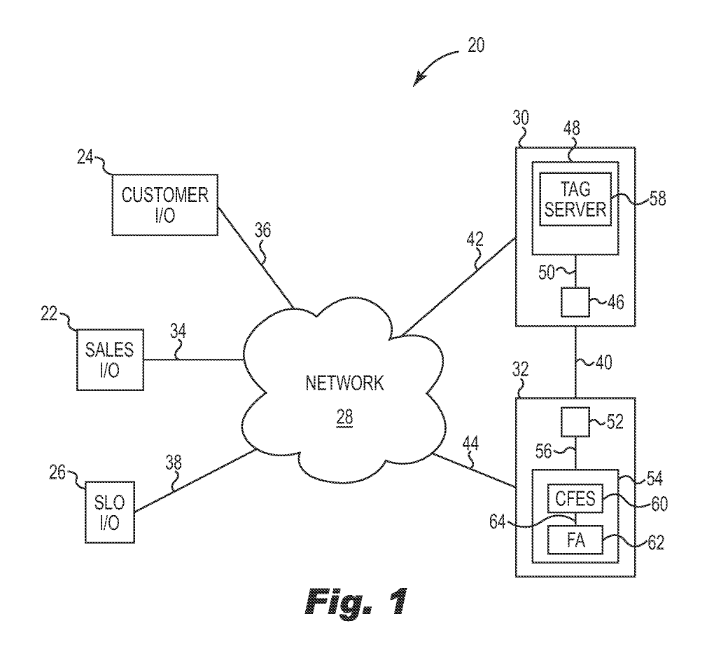

FIG. 1 is a diagram illustrating one example of a computer system 20 that includes a service sales feedback collection system. Computer system 20 includes sales input/output (I/O) devices 22, customer I/O devices 24, service line owner (SLO) I/O devices 26, a network 28, and servers 30 and 32. In other examples, computer system 20 includes one server or more than two servers, which are similar to servers 30 and 32 and provide the functionality of servers 30 and 32.

Sales I/O devices 22 are used by sales personnel to communicate over the network 28. The sales personnel can communicate with customers at customer I/O devices 24, service line owners at service line owner I/O devices 26, and servers 30 and 32 over network 28. Sales I/O devices 22 are communicatively coupled to network 28 and customer I/O devices 24, service line owner I/O devices 26, and servers 30 and 32 via communications path 34. Each of the sales I/O devices 22 communicates wirelessly and/or via wired connections with network 28. Sales I/O devices 22 include communication devices and can include personal computers, laptop computers, notebook pad computing devices, tablets, and mobile computing devices, such as telephones and personal digital assistants.

Customer I/O devices 24 are used by customers to communicate over network 28. The customers communicate primarily with sales personnel at sales I/O devices 22. Optionally, customers can communicate with service line owners at service line owner I/O devices 26 and/or servers 30 and 32 over network 28. Customer I/O devices 24 are communicatively coupled to network 28 and to sales I/O devices 22, and optionally to service line owner I/O devices 26 and/or servers 30 and 32, via communications path 36. Each of the customer I/O devices 24 communicates wirelessly and/or via wired connections with network 28. Customer I/O devices 24 include communication devices and can include personal computers, laptop computers, notebook pad computing devices, tablets, and mobile computing devices, such as telephones and personal digital assistants.

Service line owner I/O devices 26 are used by service line owners to communicate over network 28. A service line owner defines service offerings made available to customers. Service line owners are comparable to product line owners, who define product features and the evolvement of those features according to market needs. Feedback from sales personnel and customers drive the service line owner's decisions, where service offerings are changed, adjusted, packaged, and re-packaged to meet customer requirements as formulated in communications, such as customer requests for proposal or requests for response. The service line owners communicate with sales personnel at sales I/O devices 22 and servers 30 and 32, and optionally with customers at customer I/O devices 24, over network 28. Service line owner I/O devices 26 are communicatively coupled to network 28 and to sales I/O devices 22, customer I/O devices 24, and servers 30 and 32 via communications path 38. Each of the service line owner I/O devices 26 communicates wirelessly and/or via wired connections with network 28. Service line owner I/O devices 26 include communication devices and can include personal computers, laptop computers, notebook pad computing devices, tablets, and mobile computing devices, such as telephones and personal digital assistants.

Network 28 is a collection of hardware and software components interconnected by communication channels that allow sharing of resources and information. Network communications in network 28 can be wireless and/or via wired connections. In various examples, network 28 includes networks, such as the Internet, an intranet, local area networks (LANS), wide area networks (WANS), mobile networks, and enterprise networks.

Servers 30 and 32 include hardware and software components of the service sales feedback collection system. Servers 30 and 32 communicate with each other via communications path 40. Servers 30 and 32 communicate with sales personnel at sales I/O devices 22, customers at customer I/O devices 24, and service line owners at service line owner I/O devices 26 over network 28. Server 30 is communicatively coupled to network 28 and to sales I/O devices 22, customer I/O devices 24, and service line owner I/O devices 26 via communications path 42. Server 32 is communicatively coupled to network 28 and to sales I/O devices 22, customer I/O devices 24, and service line owner I/O devices 26 via communications path 44. Each of the servers 30 and 32 communicates wirelessly and/or via wired connections with network 28.

Server 30 includes one or more processors 46 that execute computer executable instructions stored in memory 48. The one or more processors 46 are communicatively coupled to memory 48 via communications path 50. The computer-executable instructions stored in memory 48 control the one or more processors 46 to provide part of the service sales feedback collection system. The one or more processors 46 are on one or more integrated circuit chips. In various examples, the one or more processors 46 include a microprocessor, a controller, a central processing unit, and/or other logic units.

Memory 48 is a computer readable storage medium storing the computer-executable instructions that control the one or more processors 46. Memory 48 is a non-transitory computer readable storage medium. In various examples, memory 48 is volatile memory, such as random access memory (RAM), and/or non-volatile memory, such as read-only-memory (ROM), programmable ROM (PROM), erasable PROM (EPROM), electrically EPROM (EEPROM), flash memory, a hard disk drive, and/or a removable hard disk drive.

Server 32 includes one or more processors 52 that execute computer executable instructions stored in memory 54. The one or more processors 52 are communicatively coupled to memory 54 via communications path 56. The computer-executable instructions stored in memory 54 control the one or more processors 52 to provide another part of the service sales feedback collection system. The one or more processors 52 are on one or more integrated circuit chips. In various examples, the one or more processors 52 include a microprocessor, a controller, a central processing unit, and/or other logic.

Memory 54 is a computer readable storage medium storing the computer-executable instructions that control the one or more processors 52. Memory 54 is a non-transitory computer readable storage medium. In various examples, memory 54 is volatile memory, such as random access memory (RAM), and/or non-volatile memory, such as read-only-memory (ROM), programmable ROM (PROM), erasable PROM (EPROM), electrically EPROM (EEPROM), flash memory, a hard disk drive, and/or a removable hard disk drive.

The service sales feedback collection system includes a tag server 58, a case feedback extraction system (CFES) 60, and a feedback aggregator (FA) 62. Tag server 58 provides for sharing and categorization of emails. Tag server 58 communicates with network 28 and sales I/O devices 22, customer I/O devices 24, and service line owner I/O devices 26 via communications path 42. Tag server 58 communicates with case feedback extraction system 60 and feedback aggregator 62 via communications path 40. Tag server 58 is stored in memory 48 and executed on the one or more processors 46 in server 30. In other examples, tag server 58 is stored in memory on multiple servers and executed on one or more processors in the multiple servers.

Case feedback extraction system 60 receives and processes a set of emails to produce information related to the set of emails. The information can be represented in a concept graph of a sales case. A concept graph is a graph of nodes and relationships that represent concepts from a sales or other business activity. A concept graph is a semantic graph of the nodes and relationships between the nodes. Evaluators in case feedback extraction system 60 evaluate the information related to the set of emails to answer one or more questions and produce evaluation results. Feedback aggregator 62 initiates evaluation of the information related to the set of emails and aggregates the evaluation results into a feedback report, which is provided to service line owners.

Case feedback extraction system 60 and feedback aggregator 62 interact via communications path 64. Case feedback extraction system 60 communicates with network 28 and sales I/O devices 22, customer I/O devices 24, and service line owner I/O devices 26 via communications path 44. Also, case feedback extraction system 60 communicates with tag server 58 via communications path 40. Case feedback extraction system 60 and feedback aggregator 62 are stored in memory 54 and executed on the one or more processors 52 in server 32. In other examples, case feedback extraction system 60 and feedback aggregator 62 are stored in memory on multiple servers and executed on one or more processors in the multiple servers.

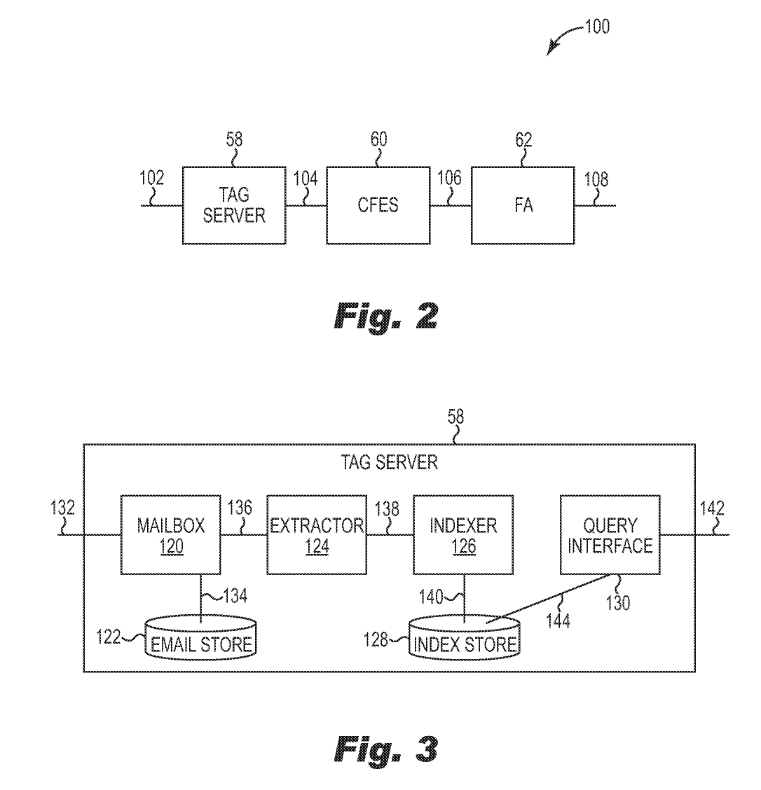

FIG. 2 is a diagram illustrating one example of a service sales feedback collection system 100 that is stored and executed on computer system 20.

Service sales feedback collection system 100 includes tag server 58, case feedback extraction system 60, and feedback aggregator 62. Sales personnel exchange and share emails with customers related to sales cases. At 102, sales personnel share at least some of these emails voluntarily with tag server 58 by copying or forwarding the emails to a mailbox at an email server address of service sales feedback collection system 100. Sales personnel use terms in the emails that identify the sales case, service(s) offered, and/or other characteristics of the case, such as sale closed and sale not closed. These terms are character strings that are specially marked, e.g., by including special characters, such as a pound/hash sign, and tags that identify the case or characteristics of the case. The character strings are later used for clustering emails into sets of emails and analysis of the sets of emails. One example character string is “#case4958”.

Tag server 58 includes the mailbox of service sales feedback collection system 100. Tag server 58 receives emails at the mailbox and stores the emails in an email storage area. Tag server 58 clusters emails into cases by correlating emails based on the contents of data fields, such as sender, receiver(s), time, subject line, and the body of the emails. A set of related emails is a case. Tag server 58 extracts one or more character strings from each of the emails stored in the email store and indexes each of the extracted character strings with a list of emails that correspond to the character string. This index of character strings and related emails is stored in an index storage area of tag server 58. In one example, a case is a sales opportunity that emerges from a customer visit with a follow-up of emails exchanged between the contact person on the customer side and one or more sales personnel on the enterprise side. In one example, a case is a sales pursuit effort that has a case number included in the emails.

To retrieve a case or a set of emails, case feedback extraction system 60 transmits a query to tag server 58, including the index storage area, via communications path 104. The query includes a character string, such as a case number or tag, which is used by tag server 58 to retrieve and transmit back a set of emails from the index storage area. Case feedback extraction system 60 receives the set of emails in response to the query. This process is repeated to retrieve another set of emails.

Case feedback extraction system 60 analyzes each received set of emails to determine relationships between the emails in a set of emails. Case feedback extraction system 60 matches character strings to emails in the set of emails and defines relationships between character strings that match at least one of the emails in the set of emails. The character strings are taken from a concept dictionary and at least some of the relationships are defined by concept classifiers stored in the case feedback extraction system 60. Case feedback extraction system 60 constructs a concept graph using the character strings that match at least one of the emails in the set of emails and the defined relationships. A concept graph is constructed for each case and each of the concept graphs is stored in memory. Case feedback extraction system 60 evaluates concept graphs and provides one or more responses to feedback aggregator 62. Case feedback extraction system 60 and feedback aggregator 62 communicate via communications path 106. In one example, after matches are discovered, the matched character strings and relationships are summarized and fully or partially reported back to service line owners, where reporting occurs as soon as a set of emails is received and analyzed by case feedback extraction system 60.

Feedback aggregator 62 includes a case repository or case list that service line owners, and other personnel interested in feedback, access to select one or more cases for feedback. Service line owners ask one or more questions about the selected cases and feedback aggregator 62 receives the one or more questions and initiates evaluation of concept graphs for the selected cases by case feedback extraction system 60. The service line owners, and other personnel interested in feedback, access feedback aggregator 62 at 108.

Evaluators in case feedback extraction system 60 evaluate each of the selected concept graphs. Case feedback extraction system 60 transmits evaluation results back to feedback aggregator 62, which aggregates the results. Each of the evaluators in case feedback extraction system 60 is configured to answer one or more questions.

Service sales feedback collection system 100 provides feedback about exchanges with customers. These exchanges include past and present exchanges as shared with service sales feedback collection system 100. Information, such as contacts involved, time frames including the first email and the last email, outcome via terms such as closed or rejected, are used for analysis and to answer questions about a case and groups of cases. Advantages of service sales feedback collection system 100 include: up to date information collected and made available as feedback to service line owners while sales personnel work with customers on service sales opportunities; small burdens placed on the sales personnel for copying and/or forwarding email to the tag server mailbox; automated collection and clustering of emails into indexed cases; broad geographic and industry coverage of sales opportunities at the scale of a large enterprise service provider; and a large case repository built up over time that allows further analysis of customers and service offerings over an extended period.

FIG. 3 is a diagram illustrating one example of tag server 58, which is part of service sales feedback collection system 100. Tag server 58 includes a mailbox 120, an email store 122, an extractor 124, an indexer 126, an index store 128, and a query interface 130.

Sales personnel exchange and share emails with customers and at least some of these emails are copied and/or forwarded to tag server 58. Mailbox 120 receives emails at 132 via an email server address of service sales feedback collection system 100. Mailbox 120 stores received emails in email store 122 via communications path 134. In one example, emails are automatically transmitted to mailbox 120. In one example, sales personnel manually copy and/or forward emails to mailbox 120.

The received emails include character strings that identify the sales case, service(s) offered, people involved, and/or other characteristics of the case, such as sale closed and sale not closed information. These character strings can include special characters, such as a pound/hash sign, that identify the character string as a tag word (tag) and make processing easier. Tags, case names, and other information are entered by sales personnel and/or customers, and in reply emails, character strings including tags are at least in the email being replied to and included with the reply. The character strings are located in various fields of the email including from/to fields, the subject line field, meta-data (header information) field, and the body of the email. In one example, a case tag includes a pound/hash sign and alphanumeric characters, such as “#case4958”. In one example, a case tag includes a special character, such as a pound/hash sign, and the name of the service offered or the name of a company. In one example, a case name is the name of the service(s) offered or the name of a company.

Tag server 58 clusters received emails into cases by correlating emails based on the character strings. Extractor 124 and indexer 126 cluster the emails into sets of emails, where each set of emails is a case.

Extractor 124 fetches emails from mailbox 120 and email store 122 via communications path 136. Extractor 124 parses through the fetched emails and extracts character strings from the emails, identifying which emails have which character strings. Extractor 124 passes the character string and email information to indexer 126 via communications path 138.

Indexer 126 receives the character string and email information from extractor 124 and constructs an index for the character strings, including the tags. In the index, each character string is associated with emails that include that character string, such that the character string acts as a pointer to a group or set of emails and each email in the set of emails includes the character string. Indexer 126 stores the index in index store 128 via communications path 140. In one example, each character string is listed in one column and emails that include the character string are listed in another column.

Query interface 130 receives queries from case feedback extraction system 60, and query interface 130 retrieves emails that match a query via index store 128. Query interface 130 transmits the retrieved emails back to case feedback extraction system 60. Query interface 130 and case feedback extraction system 60 communicate via communications path 142. Query interface 130 and index store 128 communicate via communications path 144. In one example, a query is a case tag, such as “#case4958”, and all emails related to the case are returned to case feedback extraction system 60.

Optionally, a lightweight user interface (not shown for clarity) can be used to access query interface 130 and provide queries to query interface 130 via communications path 142. Query interface 130 retrieves emails that match a query via index store 128 and query interface 130 transmits the retrieved emails back to the lightweight user interface and/or to case feedback extraction system 60.

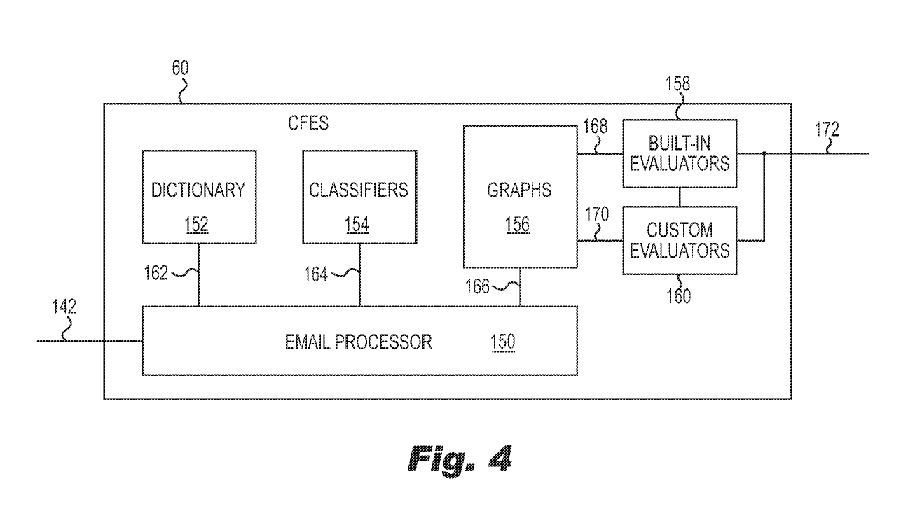

FIG. 4 is a diagram illustrating one example of a case feedback extraction system 60, which is part of service sales feedback collection system 100. Case feedback extraction system 60 includes an email processor 150, a concept dictionary 152, concept classifiers 154, concept graphs 156, built-in evaluators 158, and custom evaluators 160.

To retrieve a case or set of emails, email processor 150 transmits a query to query interface 130 via communications path 142. This query includes a character string, such as a case name or tag, which is used by query interface 130 to retrieve and transmit back a set of emails. Query interface 130 retrieves the emails that match the query from index store 128 and transmits the retrieved emails back to email processor 150 via communications path 142. This process is repeated to retrieve another set of emails.

Each set of emails includes character strings, including tags and other content, regarding a case. Information in the emails includes case identification, packages discussed, packages sold, how many packages sold, reasons for purchasing packages, and reasons for not purchasing packages. In one example, a package includes a printer service package. In one example, a package includes a hardware package. In one example, the number of emails in a set of emails is in the range of hundreds of emails, such as three hundred emails.

Email processor 150 analyzes each received set of emails to determine relationships between the emails. Email processor 150 matches character strings from concept dictionary 152 to emails in the set of emails and defines relationships between character strings that match at least one email in the set of emails, where at least some of the relationships are defined by the concept classifiers 154. Email processor 150 and concept dictionary 152 communicate via communications path 162.

Concept dictionary 152 includes a body of concepts that are of interest to a case or set of emails. Concepts are words or combinations of words (phrases) that have a meaning in a sales or business context and that are commonly used. For example, “sale closed” means that an agreement with a customer about a sale has contractually been finalized.

Each case has a corresponding concept dictionary 152, where concepts in the concept dictionary 152 are character strings, such as words and tags, related to the case. The concept dictionary 152 for a case includes character strings used in the query sent to retrieve the set of emails, and other character strings, such as package names, contact names, and case status identifiers, such as closed, sold, and rejected. In one example, concept dictionary 152 includes from dozens of character strings to hundreds of character strings.

A concept dictionary 152 for a case is constructed from predefined character strings, including tags, and from an analysis of the retrieved set of emails. To construct a concept dictionary 152, predefined character strings related to a case are entered into concept dictionary 152. These character strings include case identifiers, company names, sales personnel names, contact names, and status identifiers. Also, predefined character strings related to one or more service portfolios are entered into concept dictionary 152. A service portfolio is a catalog of service offerings, such as printer services and email services, and package names that a service line owner is in charge of. The names of the service offerings and package names and other character strings from the service portfolios for a case are entered into concept dictionary 152.

In addition, to construct and/or update concept dictionary 152, email processor 150 analyzes emails in the set of emails for other character strings, including tags, which are not predefined character strings already included in the concept dictionary 152. These other character strings can be critical or significant words and phrases in the emails, and include other tags, other service offerings, other package names, changes in service offerings, changes in package names, changes in contact names, and names of items not offered by service line owners. The other character strings are identified by statistical methods, including word frequencies, rare words, technical terms, and words or phrases that appear in multiple emails. The results of this analysis are added to concept dictionary 152.

Email processor 150 accesses concept dictionary 152 and matches character strings from concept dictionary 152 to emails in the set of emails. Also, email processor 152 accesses concept classifiers 154 via communications path 164 to define relationships between character strings that match emails. With concept classifiers 152, character strings can be identified as direct matches or partial matches. Email processor 150 categorizes the people involved, service offerings, and whether the service offering was sold, among other things. In one example, character strings are classified as individuals, such as the name of a person, and in categories, such as person or package, where the classifications of individual and category are represented as nodes in a concept graph for a case.

Email processor 150 constructs a concept graph for each case. Email processor 150 constructs a concept graph using the character strings that match at least one of the emails in the set of emails, and the defined relationships. If a character string from concept dictionary 152 matches an email, such that the character string is in the email, the character string is made into a node in the concept graph. The email includes the context of the character string, such as the person who wrote the email. This leads to a node of the person who wrote the email in the concept graph. Also, the character string is related to other character strings in the email, which are nodes in the concept graph, such as individual names, service packages, service offerings, and status identifiers, such as sold, closed the deal, and rejected. From these status identifiers, information can be ascertained about the number of service packages sold or rejected. If a matching character string is already a node in the concept graph, the email is tied to that node and other character strings in the email are made into nodes and/or tied to the already existing character string. All of these relationships form the concept graph, such that each concept graph is a relationship graph that includes matching character strings identified in the analysis of the set of emails. The character strings are put into the concept graph as nodes and the resulting data structure indicates how the nodes or character strings relate. Nodes in the concept graph include people's names, categories, service offerings, package names, each email in the set of emails, and tags. Email processor 150 stores each graph at concept graphs 156 via communications path 166.

Case feedback extraction system 60 includes built-in evaluators 158 and custom evaluators 160, which are used to evaluate concept graphs 156. Each of the built-in evaluators 158 and each of the custom evaluators 160 is configured to answer one or more questions. In one example, each evaluator is configured to answer one question.

Built-in evaluators 158 are implemented in logic, such as hardware and/or software. Custom evaluators 160 are built by writing code that is plugged into case feedback extraction system 60. Built-in evaluators 158 communicate with concept graphs 156 via communications path 168, and custom evaluators 160 communicate with concept graphs 156 via communications path 170. Built-in evaluators 158 and custom evaluators 160 provide one or more responses to feedback aggregator 62 via communications link 172.

In one example, one of the built-in evaluators 158 searches for the “last activity” in a case. The query analyzes all email nodes and identifies the most current email and the time of this most current email in the case. Another one of the built-in evaluators 158 searches for “non-service line owner personnel”, which identifies the emails and the names and email addresses of all people with email addresses that do not match the service line owner's email address. Using these evaluators, a more comprehensive evaluation is constructed to find the “last customer contact” in the case.

In another example, one of the built-in evaluators 158 searches for a “service offering name” in selected cases. The query analyzes email nodes in each of the selected cases and identifies emails and cases that include the service offering name. The built-in evaluator also searches each of the identified emails and cases for status identifiers, such as sale closed, closed, sold, and rejected. If one or more of the identified emails indicate a sale, the built-in evaluator determines that the service offering named was sold in the case and the information is sent to feedback aggregator 62 and reported to the service line owner.

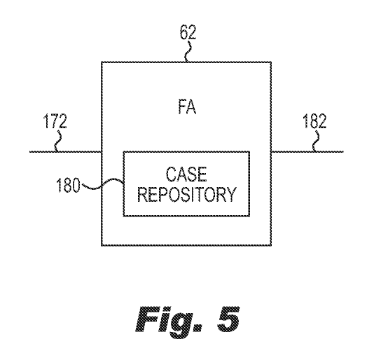

FIG. 5 is a diagram illustrating one example of feedback aggregator 62, which is part of service sales feedback collection system 100. Feedback aggregator 62 includes case repository 180, which is a list of cases in service sales feedback collection system 100. In one example, case repository 180 includes cases that have been analyzed and have a concept graph. In one example, case repository 180 includes cases that have not been analyzed, but are available for analysis and building a concept graph.

Service line owners, and other personnel interested in feedback, access feedback aggregator 62 to select one or more cases and ask one or more questions about the selected cases. Service line owners ask one or more questions about individual cases or about a group of selected cases, up to and including all cases in case repository 180. Service line owners access feedback aggregator 62 via communications path 182.

Feedback aggregator 62 receives the one or more questions and initiates evaluation of the selected concept graphs 156. To initiate evaluation, feedback aggregator 62 communicates with one or more of the built-in evaluators 158 and custom evaluators 160 via communications path 172. In response, the one or more built-in evaluators 158 and custom evaluators 160 evaluates each of the selected cases/concept graphs 156 and provides results for the one or more questions. The built-in evaluators 158 and custom evaluators 160 transmit the evaluation results back to feedback aggregator 62, which aggregates the results and provides a result to the service line owner. In one example, the service line owners can bring back specific emails to look at the emails and determine what was discussed in each of the emails.

In one example, a service line owner wants to know which customers were involved with a service package. The service line owner selects all cases in case repository 180 and asks the question. Feedback aggregator 62 communicates with one of the built-in evaluators 158 to initiate the evaluation. In response, the built-in evaluator provides a list of all cases that include discussions about the service package. The built-in evaluator transmits the result for each case back to feedback aggregator 62, which aggregates the results and provides the information to the service line owner. The service line owner can then ask another question, such as how many of the service packages were sold.

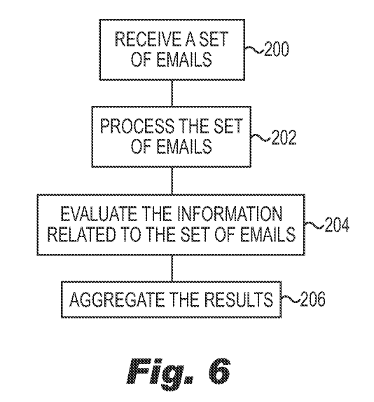

FIG. 6 is a flow chart diagram illustrating one example of service sales feedback collection system 100.

Sales personnel voluntarily share at least some emails with tag server 58. Sales personnel use terms in the emails that identify the sales case, service(s) offered, and/or other characteristics of the case. These terms are used to cluster the emails into sets of emails. To retrieve a case or set of emails, case feedback extraction system 60 transmits a query to tag server 58 and tag server 58 retrieves and transmits back the set of emails related to the query.

At 200, case feedback extraction system 60 receives a set of emails in response to a query. At 202, case feedback extraction system 60 processes the set of emails to produce information related to the set of emails. The information related to the set of emails can be represented in a concept graph or semantic graph and includes character strings, relationships between the character strings, and relationships between emails in the set of emails. The information related to the set of emails is stored in memory.

At 204, case feedback extraction system 60 evaluates the information related to the set of emails to answer one or more questions and produce evaluation results. Evaluators in case feedback extraction system 60 evaluate the information related to the set of emails and produce evaluation results. Each of the evaluators is configured to answer one or more questions. Case feedback extraction system 60 transmits the evaluation results back to feedback aggregator 62.

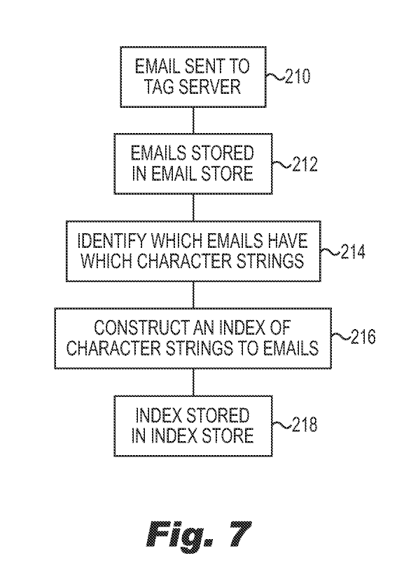

At 206, feedback aggregator 62 receives the evaluation results and aggregates the evaluation results into a feedback report. Feedback aggregator 62 includes a case repository or case list that service line owners, and other personnel interested in feedback, access to select one or more cases for feedback. Service line owners ask one or more questions about the selected cases and feedback aggregator 62 receives the one or more questions and initiates evaluation of information related to a set of emails for each of the selected cases. Feedback aggregator 62 provides the feedback report to service line owners and other personnel interested in feedback. FIG. 7 is a flow chart diagram illustrating one example of constructing an index via tag server 58. At 210, sales personnel exchange and share emails with customers and at least some of these emails are copied to tag server 58. Mailbox 120 in tag server 58 receives the emails via the email server address of service sales feedback collection system 100. At 212, mailbox 120 stores the received emails in email store 122. In one example, emails are automatically transmitted to mailbox 120. In one example, sales personnel manually copy and/or forward emails to mailbox 120.

Tag server 58 clusters received emails into cases by correlating emails based on the character strings. Extractor 124 and indexer 126 cluster the emails into sets of emails, where each set of emails is a case. At 214, extractor 124 fetches emails from mailbox 120 and email store 122 and extracts character strings from the emails, identifying which emails have which character strings. Extractor 124 passes the character string and email information to indexer 126. At 216, indexer 126 receives the character string and email information from extractor 124 and constructs an index for the character strings, including the tags. In the index, each character string is associated with the emails that include that character string, such that the character string acts as a pointer to a group or set of emails and each email in the set of emails includes the character string. At 218, indexer 126 stores the index in index store 128. In one example, each character string is listed in one column and emails that include the character string are listed in another column.

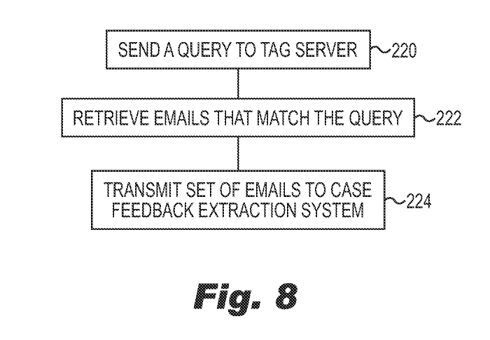

FIG. 8 is a flow chart diagram illustrating one example of case feedback extraction system 60 retrieving a set of emails from tag server 58. At 220, to retrieve a case or set of emails, email processor 150 transmits a query to query interface 130 in tag server 58. This query includes a character string, such as a case name or tag, which is used by query interface 130 to retrieve and transmit back a set of emails. At 222, query interface 130 accesses index store 128 and retrieves the emails that match the query via index store 128. At 224, query interface 130 transmits the retrieved emails back to email processor 150 in case feedback extraction system 60. In one example, a query is a case tag, such as “#case4958”, and all emails related to the case are returned to case feedback extraction system 60. This process is repeated to retrieve another set of emails.

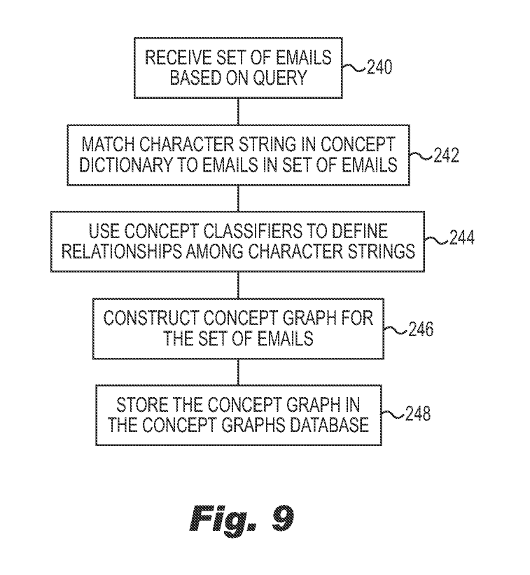

FIG. 9 is a flow chart diagram illustrating one example of case feedback extraction system 60 constructing a concept graph. At 240, email processor 150 receives a set of emails transmitted to case feedback extraction system 60 by query interface 130 in response to a query.

Email processor 150 analyzes the received set of emails to determine relationships between the emails. At 242, email processor 150 accesses concept dictionary 152 and matches character strings from concept dictionary 152 to emails in the set of emails. At 244, email processor 152 accesses concept classifiers 154 and defines relationships between character strings that match at least one email in the set of emails, where at least some of the relationships are defined by the concept classifiers 154. In one example, character strings are classified as individuals, such as the name of a person, and in categories, such as person or package, where the classifications of individual and category are represented as nodes in the concept graph for the case.

At 246, email processor 150 constructs a concept graph for the case. Email processor 150 uses the character strings that match at least one of the emails in the set of emails and the relationships between the character strings to construct the concept graph. If a character string from concept dictionary 152 matches an email, the character string is made into a node in the concept graph. The matching character string is related to other character strings in the email, which are also made into nodes in the concept graph. These character strings include items, such as individual names, service packages, service offerings, and status identifiers, such as sold, closed the deal, and rejected. If a matching character string is already a node in the concept graph, the email is tied to that node and other character strings in the email are made into nodes and/or tied to the already existing character string. All of these relationships form the concept graph and the resulting data structure indicates how the nodes or character strings relate. At 248, email processor 150 stores the concept graph at concept graphs 156.

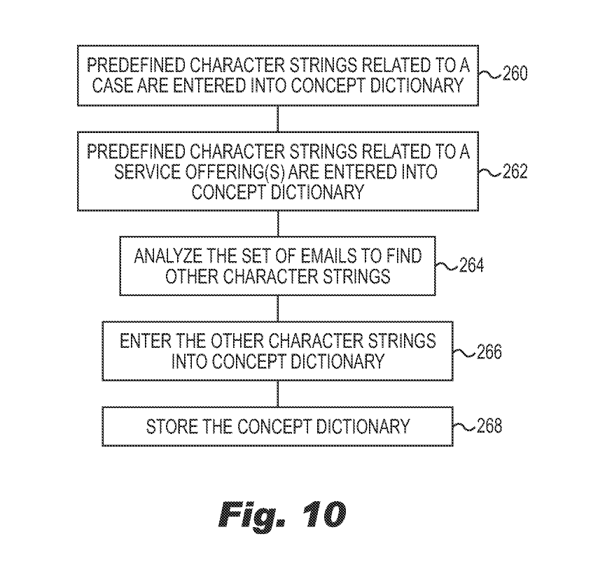

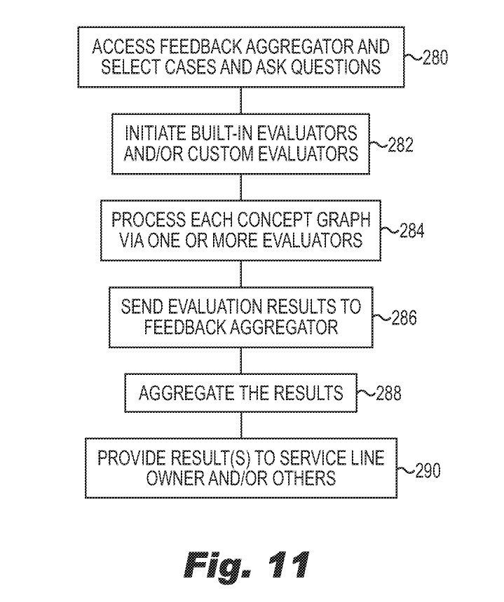

FIG. 10 is a flow chart diagram illustrating one example of constructing concept dictionary 152, which includes character strings, such as words and tags, related to a case. Concept dictionary 152 is constructed from predefined character strings and from an analysis of the retrieved set of emails.

At 260, predefined character strings related to a case are entered into concept dictionary 152. These include case identifiers, company names, sales personnel names, contact names, and status identifiers. At 262, predefined character strings related to one or more service portfolios related to the case are entered into concept dictionary 152, where a service portfolio is a catalog of service offerings and package names under the control of a service line owner. The names of service offerings and packages and other character strings from the service portfolio(s) are entered into concept dictionary 152.

At 264, email processor 150 analyzes emails in the set of emails for other character strings, which are not predefined character strings already in concept dictionary 152. These other character strings can be significant character strings in the emails and include other tags, other service offerings, other package names, changes in service offerings, changes in package names, changes in contact names, and names of items not offered by the service line owner. Other character strings can be identified by statistical methods, including word frequencies, rare words, technical terms, and words or phrases that appear in multiple emails. At 266, these other character strings are added to concept dictionary 152 that is stored at 268.

FIG. 11 is a flow chart diagram illustrating one example of retrieving feedback from service sales feedback collection system 100. At 280, service line owners and/or other personnel interested in feedback access feedback aggregator 62 and select one or more cases and ask one or more questions about the selected cases. The one or more questions are asked about individual cases or about a group of selected cases, up to and including all cases in case repository 180.

Feedback aggregator 62 receives the one or more questions and initiates evaluation of the selected concept graphs 156 at 282. To initiate evaluation, feedback aggregator 62 communicates with one or more of the built-in evaluators 158 and/or custom evaluators 160, which are used to evaluate concept graphs 156. Each of the built-in evaluators 158 and each of the custom evaluators 160 is configured to answer one or more questions. In one example, each evaluator is configured to answer one question.

In response, at 284, the one or more built-in evaluators 158 and custom evaluators 160 evaluate each of the selected case concept graphs 156. The one or more built-in evaluators 158 and custom evaluators 160 provide results for the one or more questions and, at 286, transmit the evaluation results back to feedback aggregator 62. At 288, feedback aggregator 62 aggregates the results and, at 290, feedback aggregator provides one or more results to the service line owner and/or other personnel. In one example, the service line owners can bring back specific emails to look at the emails and determine what was discussed in each of the emails.

Service sales feedback collection system 100 provides feedback to service line owners using email correspondence between sales personnel and customers. These emails include information about service offerings, service packages, contacts, time frames, and the status of sale opportunities, which are used to answer questions about a case or group of cases. Advantages of the service sales feedback collection system 100 include: up to date information; a small burden placed on sales personnel; automated collection and clustering of emails; automated evaluation of the emails; broad geographic and industry coverage of sales opportunities; and a large repository of cases built up over time that allows further analysis of customers and service offerings.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
one or more processors; and
memory that stores computer-executable instructions that control the one or more processors to:
receive a set of emails;
process the set of emails to produce information related to the set of emails;
evaluate the information related to the set of emails to answer one or more questions and produce evaluation results; and
aggregate the evaluation results into a feedback report.

2. The system of claim 1, wherein to evaluate the information related to the set of emails the computer-executable instructions control the one or more processors to:
evaluate the information related to the set of emails via one or more evaluators configured to answer the one or more questions.

3. The system of claim 2, wherein the computer-executable instructions control the one or more processors to:
receive the one or more questions; and
initiate the one or more evaluators that evaluate the information related to the set of emails and answer the one or more questions.

4. The system of claim 1, wherein to process the set of emails the computer-executable instructions control the one or more processors to:
analyze the text of emails in the set of emails to provide character strings; and
provide the information related to the set of emails based on the character strings.

5. The system of claim 1, wherein the computer-executable instructions control the one or more processors to:
receive emails at a mailbox;
store the emails in an email store;
extract one or more character strings from each of the emails stored in the email store;
index each of the character strings extracted from the emails to a list of emails that include the character string; and
store the index in an index store.

6. The system of claim 5, wherein the computer-executable instructions control the one or more processors to:
transmit a query to the index store; and
receive the set of emails in response to the query.

7. The system of claim 1, wherein to process the set of emails the computer-executable instructions control the one or more processors to:
match character strings to emails in the set of emails;
define relationships between the character strings that match at least one of the emails in the set of emails; and
construct a graph with the character strings that match at least one of the emails in the set of emails and the relationships.

8. The system of claim 7, wherein the character strings are stored in a dictionary comprising:
character strings related to a case;
character strings related to a service portfolio; and
character strings derived from an analysis of the text in emails in the set of emails.

9. The system of claim 1, wherein the information related to the set of emails includes concepts from the set of emails and relationships between the concepts.

10. A computer readable storage medium storing computer-executable instructions for controlling one or more processors to perform a method comprising:
transmitting a query to an index of character strings and related emails;
receiving a set of emails in response to the query;
processing the set of emails to identify character strings and relationships between the character strings;
constructing a graph that includes the character strings and the relationships;
evaluating the graph via at least one evaluator to provide evaluation results; and
aggregating the evaluation results.

11. The computer readable storage medium of claim 10, wherein evaluating the graph comprises:
receiving one or more questions;
initiating the at least one evaluator to evaluate the graph and answer the one or more questions; and
evaluating the graph via the at least one evaluator to answer the one or more questions.

12. The computer readable storage medium of claim 10, wherein processing the set of emails and constructing the graph comprises:
analyzing content of emails in the set of emails to determine significant character strings; and
constructing the graph to include the significant character strings and the relationships between the character strings and the significant character strings.

13. The computer readable storage medium of claim 12, wherein processing the set of emails comprises:
matching sales case character strings and service portfolio character strings and the significant character strings to emails in the set of emails; and
defining relationships between the sales case character strings and the service portfolio character strings and the significant character strings.

14. The computer readable storage medium of claim 10, the method comprising:
transmitting other queries to the index of character strings and related emails;
receiving other sets of emails in response to the other queries;
processing the other sets of emails to obtain other character strings and other relationships;
constructing other graphs that include the other character strings and the other relationships;
evaluating the other graphs via at least one evaluator to provide other evaluation results; and
aggregating the other evaluation results.

15. The computer readable storage medium of claim 14, the method comprising:
receiving one or more questions;
initiating the at least one evaluator to evaluate the graph and the other graphs and answer the one or more questions; and
evaluating the graph and the other graphs via the at least one evaluator to answer the one or more questions.

16. A computer implemented method comprising:
storing different dictionaries, each of the different dictionaries related to a corresponding case of multiple cases;
matching each of the different dictionaries to emails;
providing information for the multiple cases based on the matching;
evaluating the information via an evaluator to provide evaluation results; and
aggregating the evaluation results.

17. The computer implemented method of claim 16, wherein matching comprises:
matching each of the different dictionaries to a different set of emails.

18. The computer implemented method of claim 16 comprising:
receiving the emails at a mailbox;
storing the emails in an email store;
extracting one or more character strings from each of the emails stored in the email store;
indexing each of the character strings extracted from the emails to a list of emails that include the character string; and
storing the index in an index store.

19. The computer implemented method of claim 18 comprising:
transmitting a query to the index store; and
receiving the emails in response to the query.

20. The computer implemented method of claim 16, wherein storing different dictionaries comprises:
storing character strings related to each of the multiple cases;
storing character strings related to one or more service portfolios;
analyzing textual content of the emails to determine additional character strings; and
storing the additional character strings.
